(19) United States
(12) Patent Application Publication
(10) Pub. No.: US 2016/0027020 A1
(43) Pub. Date: Jan. 28, 2016

(54) METHOD AND APPARATUS FOR DETERMINING PARCEL BUILD SIZE

(71) Applicant: UNDERBUILT, LLC, Los Angeles, CA (US)

(72) Inventor: SHAWN PETERSON, LOS ANGELES, CA (US)

(21) Appl. No.: 14/339,424

(22) Filed: Jul. 23, 2014

(51) Int. Cl. G06Q 30/00; G06F 17/30; G06Q 50/16

(52) U.S. Cl. CPC G06Q 30/018; G06Q 50/165; G06F 17/30241; G06F 17/30864

(57) ABSTRACT

A system and method for determining the maximum building size that may be constructed on a real property parcel includes databases of applicable governmental regulations that affect building size within a specific locality, the size and location of the real property parcel, and specifically a means to determine slope analysis from digital terrain data of the specific real property. The system and method correlates the information from the databases and generates a report maximum building size construction planning.

This application claims the benefit of U.S. Provisional

Application No. 61/857,327, filed on Jul. 23, 2013.

### FIELD OF THE INVENTION

The present invention relates generally to methods and systems for investigating allowable construction limitations relating to real estate parcels and, more particularly, to a computer-implemented method and system for collecting and storing real estate -related data, namely information related to slope analysis per building codes, searching the collected data, and generating a report which identifies the maximum size of a building in relation to said slope analysis that may be constructed on the real estate parcel.

### BACKGROUND OF THE INVENTION

Owners of real property or land developers often desire to construct buildings and improvements that maximize the use of their property. There are many reasons for doing so.

Historically, building codes have been developed, adopted, implemented, and enforced to ensure public safety and more recently have addressed issues such as energy efficiency, water use and sustainability. These codes, and standards that are referenced in the codes, are primarily developed in the voluntary sector (e.g. non-regulatory sector) and then adopted and applied by Federal, state and local governments as building rules and regulations. These building rules and regulations must be satisfied by building designers, owners, manufacturers, contractors and others involved in the design, construction, commissioning or operation of any aspect of a building and its systems. As used herein, the terms building codes and regulations are used interchangeably and are each intended to include the body of criteria one must or is directed to follow in the design, construction, commissioning, operation and maintenance of buildings within a given locality.

One common problem is with regards to obtaining the slope analysis per business codes. The only means of creating slope analysis is through a surveyor who must physically enter the property with a variety of mechanical equipments. Such physical presence can be very wasteful as to the amount of time and resources. The surveyor must then take the data measurements, and then painstakingly analyze the data, and produce their report and maps of the slope analysis per building. The process can take weeks or months and ultimately be very expensive to the land developer.

There are also potential safety hazards as the surveyor must traverse steep terrain or hillsides that may be covered in dense brush. Such measurements will often be less accurate because of this.

Utilizing older methods to measure available square footage on a property has restrictions that are found in almost all building codes. The goal is to determine the maximum allowable floor area for any building that may be constructed on a particular real estate parcel. In the United States, this area is typically measured in units of square footage. However, other equivalent units may be used, such as square meters.

The maximum allowable size is generally not uniform for all real estate parcels in a given municipality. The maximum allowable size is also complicated by attempting to incorporate the size once the slope analysis per building code is ascertained. If the slope analysis measurements are inaccurate or require substantial amount of time to make such determination, the land developer may ultimately absorb the added cost due to error and delay.

In addition, other factors may limit or constrain the size of the building. These include zoning regulations. Residential properties generally have different building limitations than commercial properties. Also, building setbacks and slope terrain may also limit the size of the build if not accounted for or properly ascertained.

To obtain information about allowable building limitations and restrictions, abstractors, alternately known as searchers or examiners, seek out various official records in an effort to determine the existence and effect of governmental codes, statues or other limitations that might affect rights in the property. Such a search is usually performed manually at a local government repository, e.g., the county clerk's office.

A typical search process begins when a homeowner, architect or contractor desires to design a building to be located on a particular property. Alternatively, it may be desired to improve or add-on to an existing property. The title company then instructs one or more abstractors to begin a title search. For example, an abstractor will likely search the records of the local county clerk's office and courthouse, as well as the records of the local tax office. Other governmental sources may also be searched, depending on the location and type of property.

In order to determine a parcel build size, it is first necessary to compile information concerning the specific real estate parcels that are present within a given locality. Due to the manner in which most county clerks maintain their real estate records, a property search is generally performed by searching a party's name. All of the instruments filed with the county clerk having that particular name are then identified, resulting in a very large number of documents, particularly if the name is common. The searcher must then review each of the identified documents to determine which ones are relevant. This is, of course, dependent on the abstractor locating the hard copy record and/or microfilm reel containing the needed document.

It is also necessary to compile all relevant building codes and other governmental regulations that affect the ability to construct buildings on a specific parcel. If and when the needed document is located, the required information is generally abstracted off the document onto a “scratch pad. This process is widely used due to a general lack of adequate copying facilities within a county clerk's office, or the typical delay associated with such copying. It will be appreciated that such delays may involve occupied or broken copy machines, as well as bureaucratic delays if the copying is done by a government employee.

Thus, abstractors are hampered by the government's cumbersome and antiquated methods of storing records, as well as the lack of access to such records outside of normal government business hours. At best, it takes hours to manually search, locate, and review the data required to produce the report. The nature of this process also increases the likelihood of error. For example, the need to manually abstract the required information from an original document to a scratch pad can result in inaccuracies, misspellings or other such mistakes in the report. Once all the information is obtained, the abstractor generally compiles the information in a report. This can result from transcribing errors, to handwriting illegibly, or to lost or misplaced data sheets.

If the property has a sloped terrain, the owner or land developer may also require information about slope analysis per building code. The owner or land developer would normally arrange an appointment with surveyor to have a costly slope analysis performed physically on the subject property. The surveyor would bring heavy equipment on-site and face having to traverse steep terrain or heavy brush. Such obstacles may give rise to substantial error. If such physical analysis were done before, and the information that may have been already recorded in government held records may have the same errors or not adequately updated due landscape changes or erosion over time.

Abstractors also may be unable to find any relevant documents pertaining to certain parts of the land as slope analysis was not previously done on undeveloped parcels. Surveyors are also limited in their ability to report slope analysis for large parcels.

There is therefore a need in the art for a system for collecting, sorting and storing of selected real estate related data in a readily searchable mode, thereby allowing searches to be conducted when needed (not limited by the office hours of the government repository), to be conducted at a remote site, to be able to retrieve all identified records, to be able to readily obtain copies of any such record. There is also a need to create a slope analysis per building codes in digital form so that the data can be obtained much faster, with less error and less cost.

There is a further need in the art for a system which is adapted to receive and integrate regular periodic updates from various disparate sources, e.g., county clerks' office. Ideally, this system should be capable of monitoring the quality of the incoming data. There is also a need in the art for a system which provides an improved mode of searching records relating to building codes and governmental regulations that affecting a particular property. Finally, there is a need in the art for a system that facilitates the initial preparation of a build size report, while reducing the likelihood of error being subsequently introduced into the report.

Thus, it would be desirable to provide an accurate, efficient and cost effective method and system for generating reports that include slope analysis per building codes, for the ability to determine the maximum size of a building that may be built or constructed on a given parcel of real property.

### INVENTION SUMMARY

The present invention teaches a system for determining the maximum building size that may be constructed on a real property parcel, and in particular, the incorporation of slope analysis data to this building size determination. The system includes at least a first database stored on a computer which includes applicable governmental regulations that affect building size within a specific locality, a second database stored on a computer which includes information concerning real property parcel dimensions and location within the locality, and specifically means to determine slope analysis from stored digital terrain data of a specific real property within the locality.

The system combines and compares the information from the second database with information from the first database and generates a report for a specific parcel of real property. A report may include at least a calculation of the maximum size building that may be constructed on a parcel of real property for which the calculation is based on information contained in the first and second databases. A user of the system may obtain the report directly from the system's computer or from an internet website through the user's computer or mobile device.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF DRAWINGS

FIG. 1 is a block diagram showing an exemplary embodiment of the invention's major elements of a system for implementing an embodiment of the present invention, and

FIG. 2 depicts how digital topological data is manipulated and reported.

### DETAILED DESCRIPTION OF PREFERRED EMBODIMENTS

The present invention provides a method and apparatus for determining parcel build size, and namely, incorporating in the determination slope analysis per building codes. In the following description, numerous specific details are set forth to provide a thorough understanding of the present invention.

In other instances, well-known details have been omitted so as not to obscure the present invention unnecessarily. It will be appreciated, therefore, by one skilled in the art that the present invention may be practiced in a more general application where such advantages provided by this invention are desired.

According to the present invention, digital slope analysis per building codes is created with digital terrain data, herein as DTD. DTD includes data commonly obtained from digital terrain modeling and digital elevation modeling and any other equivalent collected terrain data that may be imported into the present inventions system. DTD is used to model topographical maps. Accuracy of DTD analysis relies heavily on statistical methods. The data has thousands of points of reference per property without any terrain being physically navigable through steep conditions or dense brush and hazards.

The DTD slope analysis is more accurate and involves less risk of hazard or injury than physically obtained measurements. Adding one or more constraints to the algorithms of data can improve the accuracy of the data. DTD can also produce slope analysis for parcels that were previously unavailable because the parcel was too large. In addition, a digital format allows substantial data to be stored in one compact database that allows quick and easy access through the internet from anywhere in the world.

DTD slope analysis obtained may then be related to the necessary building codes for one or many parcels. The data are correlated to building code legislation, tax regulators, and property developers. The DTD slope analysis per building codes allows the land developer to have a far more efficient means in planning development then the traditional means.

Further to the invention, a protocol and software program may assist those familiar with the codes standards, regulations and other building-related criteria relating to parcel building size. The method and apparatus (or, alternatively, the system) of the present invention allows one to automatically check a specific real estate parcel to determine how large of a building may be built on a given lot. In an alternative embodiment, the system and method of the present invention can be used to determine how much additional square footage may be added to an existing building on a lot.

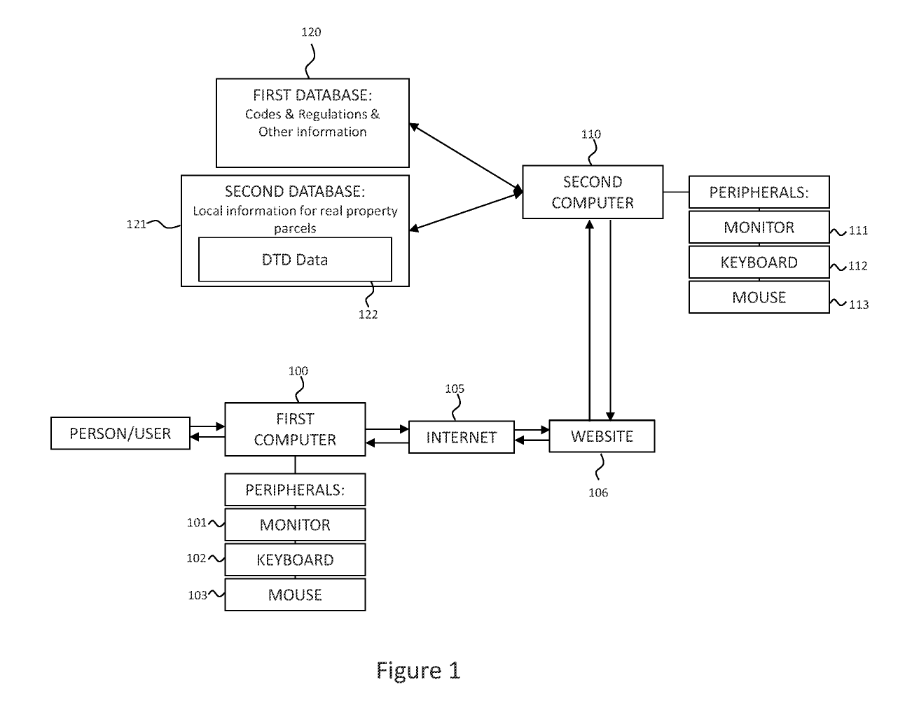

Referring first to FIG. 1, a system implementing an embodiment of the present invention is illustrated. The elements of the system include a first computer 100 wherein said first computer 100 has input-output peripherals. In the illustrated embodiment, the peripherals include a monitor or display 101, keyboard 102 and a mouse 103 or manually manipulated interface cursor control that are connected to the first computer 100. In the preferred embodiment, the first computer illustrated is connected to the internet 105. However, in an alternative embodiment, the system can operate on a stand-alone, local system (not shown).

Referring again to FIG. 1, the first computer 100 is shown connected, via the internet 105, to a website 106. The website 106 is connected to a second computer 110 having input-output peripherals as illustrated, for example, monitor 111, keyboard 112, and mouse 113. The second computer 110 contains a first database 120. The first database 120 includes a summary of relevant municipal building codes, state statutes and regulations and other governmental limitations that effect the size of a building that can be built within a given locality or municipality. The governmental restrictions may also include limitations to air and soil rights.

In addition, there may be other non-governmental restrictions that are placed in the first database 120. For example, a local homeowners' association may place limits on the size of houses that can be built in a residential area. Other limits may include but are not limited to deed and neighborhood restrictions, and covenants, conditions and restrictions (CC&Rs). Alternatively, in a commercial setting, contractual agreements, or private easements can limit the size of offices or other business-related buildings. Such agreements may also include limitations based on air and soil rights.

Also contained in the second computer 110 is a second database 121. The second database 121 includes information for real property parcels located within the locality of interest. This information will generally be taken from a county recorder's office. In addition, DTD data 122 can be included within the second database 121 which DTD data provide the information needed to provide slope analysis about each parcel that might be relevant to building size and the associated building codes. In an alternative embodiment, first database 120 and second database 121 can be combined into a single database.

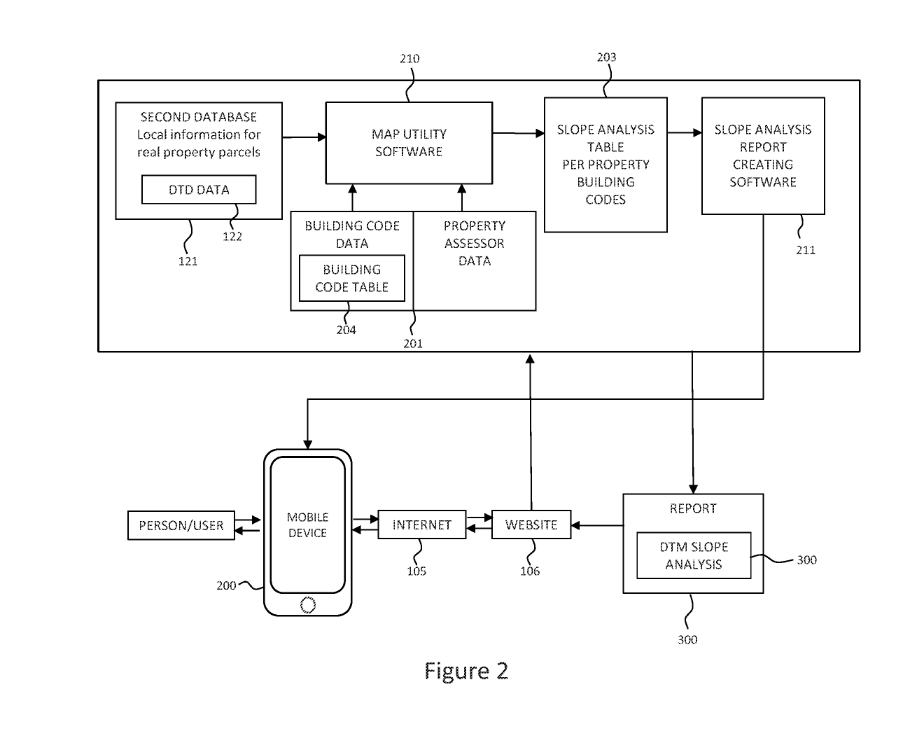

Referring next to FIG. 2, a user of the invention obtains a DTD slope analysis report 300 by simply selecting the options by inputting the identity or location of a select parcel or set of parcels by a computer or mobile device 200. The mobile device 200 shown may then access data from the DTD data 122 stored in the second database 121, and a slope band data table 203 may be created using map software 210. In the alternate to the use of a slope band data table, the map software 210 may generate an average slope from multiple raw data sets or provide values from other terrain measurements as required by the parcel's local codes. The map utility software 210 and related methods are not described herein, but will be well known to those of skill in the art.

The process of compiling the first database 201 as shown in the FIG. 2 embodiment may require building codes and/or property assessor data or other third party assessor data. Such data that would be used would be in accordance with the DTD data 122, and may require a manual search of all applicable governmental regulations and other publicly-available information. The search may include researching permits in areas with sloped terrain and stored in the first database 201. The applicable building codes may be compiled into Building Code Data table 204.

This compiling process is not automated, and requires human input which may be accomplished by the use of the second computer 110 or other inputting means. This is because relevant information, including building zones and codes are sometimes located on governmental records that are only accessible by physical inspection. In another instance, the building codes are deep within large PDF documents on city websites and it is very difficult to navigate to the information and understand the information required. Different residential and commercial properties in different zones, cities, counties require different data in order to correctly perform calculations to get the maximum buildable area. The system of the present invention collates data from multiple sources into the database.

As an optional embodiment, the system may include means for automatically updating property assessor database 201 and second database 121 when building codes changes or information concerning parcel sizes (such as subdivisions) is recorded.

The databases may also be accessed by the mapping utility software 210 which the software 210 uses DTD information in the second database 121 to generate a slope analysis table 203 and then compares slope analysis to building codes and regulations in the first database 201 to generate a report 300 for the size of a building that can be built on the property over the sloped terrain. The specific computer codes and methods are not described herein, but will be well known to those of skill in the art.

A user visits a website 106 or application with a first computer 100 or mobile device 200. A user may install slope analysis report creating software 211. The user may then submit a request to the slope analysis report creating software 211, and a calculation is done per building code to display the slope analysis report on a monitor 101 as shown in FIG. 1 or a mobile device 200 as shown in FIG. 2. With reference to FIG. 2, the user then either searches sale listings that have been already integrated into the generated report 300 or selects the option to manually enter a specific property's address and information to generate for a property specific type of report 300.

In one embodiment, the system of the present invention as shown in FIG. 2 selects the proper components from the building code data and property assessor data 201 and the second database 121, per property, and then performs the proper calculations to generate a report 300 dynamically. This allows the system to ensure that the reports 300 are generated with the current data. The report 300 may contain colored terrain maps to help visualize the data sets. In an alternative embodiment, the calculations are performed in advance for each property within a particular location and the report 300 is then stored in memory. The pre-prepared reports 300 reduces the amount of time that might be needed to present the report 300 to a user.

In this report 300 the user sees an overall comparison score given in percentage form. The user also sees how this comparison was generated, who the identity of the city official that supplied the information, and when the date in which the information was acquired. The user can then have this report 300 sent to them or print out a hardcopy for their records. A user must select a property from a list or enter information of their property to have a report 300 generated.

This report 300 may quickly answer the question, “What can I build and at what size on this property?” thereby saving users both time and money. The user may then seek professional assistance in purchasing the property in question or if they own the property they may call a professional to help them improve on the property.

In an alternative embodiment, the invention may produce a comparison parcel report showing the specific building types and sizes that are allowed on that parcel as compared to the existing structures.

A typical report 300 may include information about the real estate parcel of interest and in particular, the slope analysis per building codes 203. In addition to the slope analysis per building code information, other information may include location information such as a street address or lot number. Other information about the parcel may include a description of terrain conditions other than the slope analysis per building codes. Information about pre-existing structures on the property can also be included. This includes a description of existing buildings that may have been previously constructed. Of particular interest would be the size and amount of square footage of the existing buildings. In another alternative embodiment, the report would eliminate any reference to existing buildings. This would be useful when a property owner intends to construct an entirely new building on the property. The report may optionally include information about the value of the property and/or pre-existing buildings and tax assessments and payments.

The report may include an analysis of the amount of square footage that can be legally built on the property. When a building already exists on the property, the report 300 will display the amount of square footage that can legally be added to the building, in accordance with existing codes and regulations. In the alternative, the report may display the maximum size of a building that can be constructed. This information is useful for new construction projects on the real estate parcel. Finally, the report 300 will include information concerning the specific building codes or other governmental regulations that have an effect on the size of the building to be constructed.

After the report 300 is generated, it can be used in a number of different ways. The report 300 can be a basis for supporting an estimate of the value of the real property, because valuation often depends on the size of the building on a particular location. In another embodiment, the report can be used to assist an architect or contractor to design an addition to an existing structure that will increase or maximize the size of the building on the site.

As a next step, a building or addition can be constructed based upon the information generated from the system. It is clear that the primary utility of the system is the creation of a suitable structure for the real estate parcel.

A system and apparatus for determining parcel build size have been disclosed. Although the present invention has been described in terms of a preferred embodiment, it will be appreciated that various modifications and alterations might be made by those skilled in the art without departing from the spirit and scope of the invention. Therefore, the invention should be measured only in terms of the claims which follow.

What is claimed is:

1. A system for determining the maximum size building that may be constructed on a real property parcel, comprising:
a first database for storing applicable governmental regulations that affect building size within a specific locality;
a second database for storing information concerning digital topological data of real property within said specific locality; and
a means connected to said first and second databases for generating a report for a specific parcel of real property, said report including at least a calculation of the maximum size building that may be constructed on said specific parcel of real property, said calculation being based on information contained in said first and second databases.

2. The system of claim 1 wherein said means connected to said first and second databases for generating a report is initiated by the parameters inputted by a user's query to said system.

3. The system of claim 1 wherein said report incorporates building codes and governmental regulations which are used to create plans for building a structure on said parcel, wherein said plans defining a structure with a size that is no larger than a maximum building size that may be built on said property.

4. The system of claim 1 wherein said digital topological data is generated from digital terrain model data and said digital terrain model data being used to create a slope data table.

5. A method for determining the maximum size building that may be constructed on a real property parcel, comprising:
compiling a first database including applicable limitations that affect building size within a specific locality, said compiling step being accomplished by at least searching governmental codes and regulations;
compiling a second database including information concerning real property topological data, parcel area, and location within said locality, said compiling step receiving a query from a user, said query containing an identification of at least one specific parcel of real property, wherein information related to said specific parcel of real property is located within said second database;
preparing a report for said specific parcel of real property, said report including at least a calculation of the maximum size of a building that may be constructed on said parcel of real property, said preparing step being performed by combining information contained in said first database with information in said second databases.

6. The method of claim 5 further comprising the step of constructing a building in accordance with said plans.

7. The method of claim 5 further comprising the step of constructing an addition to an existing building on said parcel in accordance with said plans.

8. The method of claim 5 further comprising generating topological data from digital terrain model data to create a slope data table.

9. A method for constructing a building on a real property parcel, comprising:
compiling a first database including applicable limitations that affect building size within a specific locality, said compiling step being accomplished by at least searching governmental codes and regulations;
compiling a second database including information concerning real property topological data, parcel area and location with said locality, said compiling step;
receiving a query from a user, said query containing an identification of at least one specific parcel of real property, wherein information related to said specific parcel of real property is located within said second database;
preparing a report for said specific parcel of real property, said report including at least a slope band data table, a building data code table consistent with the slope band data table, and a calculation of the maximum size of a building that may be constructed on said parcel of real property, said preparing step being performed by combining information contained in said first database with information in said second databases;
utilizing said report to create plans for building a structure on said parcel, said plans defining a structure having a size that is no larger than a maximum size building that may be built on said property in accordance with building codes and governmental regulations; and
constructing said building in accordance with said plans.
